(19) United States
(12) Patent Application Publication
(10) Pub. No.: US 2006/0114364 A1
(43) Pub. Date: Jun. 1, 2006

(54) Dual mode liquid crystal display device

(75) Inventor: Chien-Ting Lai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/288,748

(22) Filed: Nov. 28, 2005

(30) Foreign Application Priority Data
Nov. 26, 2004 (TW) 93136461

(51) Int. Cl. G02F 1/1343

(52) U.S. Cl. 349/38

(57) ABSTRACT

An LCD device (100) includes a first substrate (110), a second substrate (120), and a liquid crystal layer (130) having liquid crystal molecules interposed between the first and second substrates. A pixel electrode (112) is disposed at an inner surface of the first substrate, and a common electrode (122) is disposed at an inner surface of the second substrate. A storage capacitor (140) has an upper storage electrode (118) and a lower storage electrode (113) disposed at the inner surface of the first substrate, with the upper storage electrode electrically connecting with the pixel electrode. One of the storage electrodes functions as a reflection electrode, and a transflective film (119) is formed at the first substrate, so as to provide reflective and transmission display functions simultaneously. Therefore, the LCD device can provide a bright display under various ambient light conditions.

### FIELD OF THE INVENTION

The present invention relates to liquid crystal display (LCD) devices, and more particularly to a reflection/transmission type LCD device capable of providing a display both in a reflection mode and a transmission mode.

### BACKGROUND

Conventionally, Cathode Ray Tubes (CRTs), Electroluminescence (EL) displays, Plasma Display Panels (PDPs) etc. have been put into practical use as light emissive type displays, in which the content of the display can be overwritten electrically.

However, these types of light emitting displays generally have high power consumption. Further, the light-emitting surfaces of these types of displays are highly reflective. Therefore if the display is used under circumstances where the ambient light is brighter than the luminance (for example, in direct sunlight), then a phenomenon known as “wash-out” frequently occurs, and the display cannot be easily observed.

On the other hand, LCD devices have been put into practical use as non-light emissive type displays. That is, LCD devices display characters and/or images by using a background light source rather than by emitting a display light. These LCD devices include a transmission type LCD device and a reflection type LCD device.

Of the above-mentioned two types of LCD devices, the transmission type is more popular. The transmission type LCD device employs a light source called a “backlight” behind the liquid crystal cell. Since transmission type LCD devices are advantageous due to their thinness and light weight, they have been used in numerous different fields. However, transmission type LCD devices consume a large amount of power to keep the backlight on. Thus, even though only a small amount of power is consumed to adjust transmittance of liquid crystals of the LCD device, a relatively large amount of power is consumed overall.

Transmission type LCD devices wash out less frequently compared with light emissive displays. In particular, in the case of color transmission type LCD devices, the reflectance on the display surface of a color filter layer is reduced by reflectance reducing means such as a black matrix.

It becomes difficult to readily observe the display on color transmission type LCD devices when they are used under circumstances where the ambient light is very strong and the display light is relatively weak. This problem can be mitigated or eliminated by using a brighter backlight, but this solution further increases power consumption.

Unlike light emissive displays and transmission type LCD devices, reflection type LCD devices show the display by using ambient light. Thereby, a brightness of the display is proportional to the amount of ambient light. Thus, reflection type liquid crystal displays are advantageous insofar as they do not readily wash out. When used in a very bright place in direct sunlight, for example, the display can be observed all the more sharply. Further, the reflection type liquid crystal display does not use a backlight, and therefore has the further advantage of low power consumption. For the above reasons, reflection type LCD devices are particularly suitable for outdoor use, such as in portable information terminals, digital cameras, and portable video cameras.

However, since reflection type LCD devices use ambient light for the display, the display luminance largely depends on the surrounding environment. When the ambient light is weak, the display cannot be easily observed. In particular, in the case where a color filter is used for realizing the color display, the color filter absorbs much light and the display is darker. Thus, when the LCD device is used under these circumstances, the ambient light problem is even more pronounced.

Therefore, what is needed is a transflective LCD which can overcome the above-described problems.

### SUMMARY

An LCD device includes a first substrate and a second substrate, and a liquid crystal layer having liquid crystal molecules interposed between the first and second substrates. A pixel electrode is disposed at an inner surface of the first substrate, and a common electrode is disposed at an inner surface of the second substrate. A storage capacitor has an upper storage electrode and a lower storage electrode disposed at the inner surface of the first substrate, with the upper storage electrode electrically connecting with the pixel electrode. One of the storage electrodes functions as a reflection electrode, and a transflective film is formed on the first substrate. Thus reflective and transflective display functions can be provided simultaneously.

With the above-described configuration, the LCD device can effectively use light emitted from a backlight and passing through the transflective film when the ambient light is low, and light reflected by the storage electrode and the transflective film when the ambient light is high. Further, both the transflective region and the reflection region can be used to generate a display, therefore the LCD device is capable of providing a display both in a reflection mode and a transmission mode simultaneously. Moreover, the LCD device can provide a bright display under various ambient light conditions.

Other advantages and novel features will become more apparent from the following detailed description when taken in conjunction with the accompanying drawings.

### BRIEF DESCRIPTION OF THE DRAWINGS

FIG. 1 is a schematic, side cross-sectional view of part of an LCD device according to a first embodiment of the present invention.

FIG. 2 is a schematic, side cross-sectional view of part of an LCD device according to a second embodiment of the present invention.

FIG. 3 is a schematic, side cross-sectional view of part of an LCD device according to a third embodiment of the present invention.

FIG. 4 is a schematic, side cross-sectional view of part of an LCD device according to a fourth embodiment of the present invention.

FIG. 5 is a schematic, side cross-sectional view of part of an LCD device according to a fifth embodiment of the present invention.

FIG. 6 is a schematic, side cross-sectional view of part of an LCD device according to a sixth embodiment of the present invention.

FIG. 7 is a schematic, side cross-sectional view of part of an LCD device according to a seventh embodiment of the present invention.

FIG. 8 is a schematic, side cross-sectional view of part of an LCD device according to an eighth embodiment of the present invention.

FIG. 9 is a schematic, side cross-sectional view of part of an LCD device according to a ninth embodiment of the present invention.

### DETAILED DESCRIPTION OF PREFERRED EMBODIMENTS

FIG. 1 is a schematic, side cross-sectional view of part of an LCD device according to a first embodiment of the present invention. The LCD device 100 includes a lower substrate 110, an upper substrate 120 disposed parallel to and spaced apart from the lower substrate 110, and a liquid crystal layer 130 having liquid crystal molecules (not labeled) sandwiched between the substrates 110 and 120.

A thin film transistor (TFT) 111, a pixel electrode 112, a transflective film 119, and a storage capacitor 140 are disposed at an inner surface of the lower substrate 110. The TFT 111 includes a gate electrode 114, a source electrode 115 and a drain electrode 116, with the drain electrode 116 being electrically connected to the pixel electrode 112. The storage capacitor 140 includes a lower storage electrode 113 and an upper storage electrode 118, with the upper storage electrode 118 being electrically connected with the pixel electrode 112. The lower and upper storage electrodes 113, 118 cooperate with an insulating film 108 to form capacitors. The transflective film 119, the upper storage electrode 118, and a passivation layer 117 are formed between the insulating film 108 and the pixel electrode 112, and the transflective film 119 and the upper storage electrode 118 are formed substantially at a same layer.

A material of the upper storage electrode 118 is a highly reflective conductive material, such as Al, Ag, AlNd or AlY. Thus the upper storage electrode 118 functions as a reflection electrode. A material of the pixel electrode 112 is a transparent material, such as Indium Tin Oxide (ITO) or Indium Zinc Oxide (IZO).

The transflective film 119 has a multi-layer construction, and commonly includes seven to nine layers. In particular, the transflective film 119 includes a plurality of layers of different transparent materials stacked one on the other in alternating fashion. The layers are typically SiO₂ films, TiO₂ films, Nb₂O₅ films, ZnO₂ films and Si₃N₄ films. The refractive ratio and thickness of each of the layers can be configured according to need, and the number of layers can also be configured according to need. In this way, the transflective film 119 will have a desired transmission ratio and reflective ratio.

A color filter 121 and a common electrode 122 are disposed on an inner surface of the upper substrate 120 in that order. The color filter 121 includes a color region 124 and a black mask 125. The black mask 125 is positioned corresponding to the TFT 111, in order to prevent ambient light from irradiating the TFT 111.

The pixel electrode 112, the common electrode 122, and the liquid crystal layer 130 between the pixel electrode 112 and the common electrode 122 cooperatively define a pixel region of the LCD device 100. The pixel region includes a transflective area and a reflection area. The area of the pixel region corresponding to the transflective film 119 is referred to as the transflective area, and the area of the pixel region corresponding to the upper storage electrode 118 is referred to as the reflection area. In the transflective area, light beams emitted by a backlight (not shown) can pass through the transflective film 119 and ambient light is reflected by the transflective film 119, thereby providing a reflection/transmission display function. In the reflective area, ambient light is reflected by the upper storage electrode 118, thereby providing a reflection display function.

With the above construction, the LCD device 100 is able to effectively use light emitted from the backlight and passing through the transflective area when the ambient light is low, and light reflected by both the reflection area and the transflective area when the ambient light is high. Further, both the transflective area and the reflection area can be used to generate a display. Therefore the LCD device 100 is capable of providing a display both in a reflection mode and a transmission mode simultaneously. Moreover, the LCD device 100 can provide a bright display under various ambient light conditions.

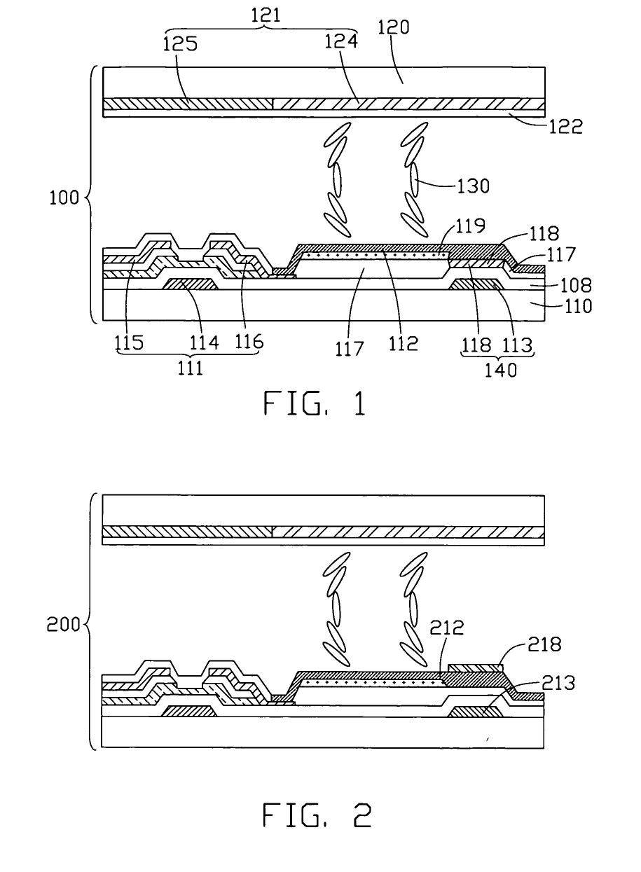

FIG. 2 is a schematic, side cross-sectional view of part of an LCD device according to a second embodiment of the present invention. The LCD device 200 has a structure similar to that of the LCD device 100. However, in the LCD device 200, part of a pixel electrode 212 is referred to as an upper storage electrode of a storage capacitor, the upper storage electrode together with a lower storage electrode 213 forming the storage capacitor. In addition, a reflector 218 disposed on the pixel electrode 212 corresponds to the lower storage electrode 213. A material of the reflector 218 is a highly reflective material, such as Al, Ag, AlNd, AlY, or resin. Therefore the upper storage electrode and the reflector 218 are together referred to as a reflection electrode. In the second embodiment, the pixel region corresponding to reflector 218 is referred to as the reflection area. The reflection area provides a reflection display function.

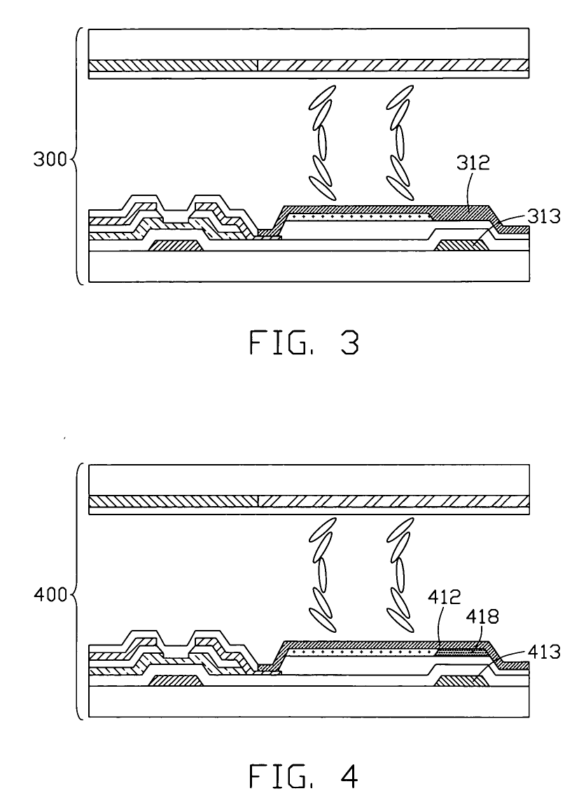

FIG. 3 is a schematic, side cross-sectional view of part of an LCD device according to a third embodiment of the present invention. The LCD device 300 has a structure similar to that of the LCD device 100. However, in the LCD device 300, part of the pixel electrode 312 is referred to as an upper storage electrode of a storage capacitor, with the upper storage electrode together with a lower storage electrode 313 forming the storage capacitor. In addition, a material of the lower storage electrode 313 is a highly reflective conductive material, such as Al, Ag, AlNd, or AlY. Therefore the lower storage electrode 313 functions as a reflection electrode. In the third embodiment, the pixel region corresponding to the lower storage electrode 313 is referred to as the reflection area. The reflection area provides a reflection display function.

FIG. 4 is a schematic, side cross-sectional view of part of an LCD device according to a fourth embodiment of the present invention. The LCD device 400 has a structure similar to that of the LCD device 100. However, in the LCD device 400, an upper storage electrode 418 that connects with a pixel electrode 412 is a transparent electrode. In addition, a material of a lower storage electrode 413 is a highly reflective conductive material such as Al, Ag, AlNd, or AlY. Therefore the lower storage electrode 413 functions as a reflection electrode.

FIG. 5 is a schematic, side cross-sectional view of part of an LCD device according to a fifth embodiment of the present invention. The LCD device 500 has a structure similar to that of the LCD device 100. However, in the LCD device 500, an upper storage electrode 518 has an uneven surface, thereby defining a plurality of bumps 520. A material of the upper storage electrode 518 is a highly reflective conductive material, such as Al, Ag, AlNd, or AlY. Therefore the upper storage electrode 518 functions as a reflection electrode. The bumps 520 may scatter light beams in order to avoid the so-called mirror reflection effect.

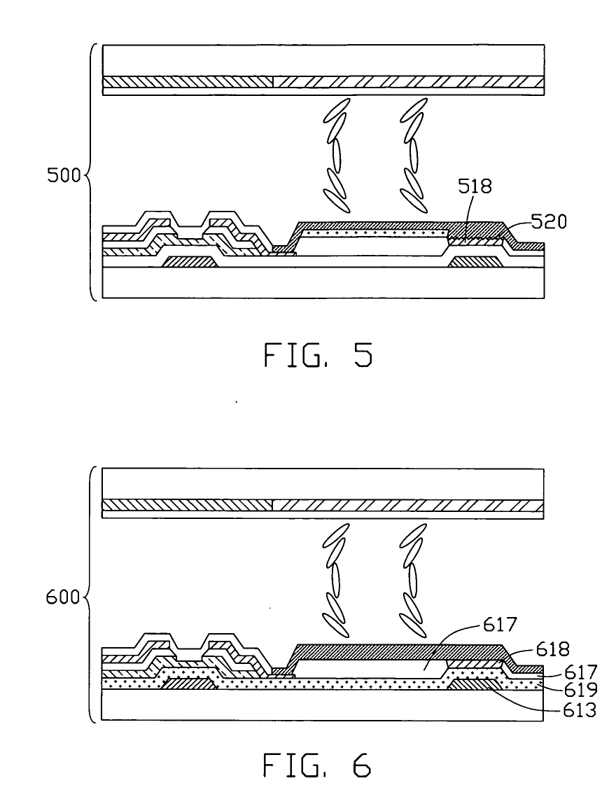

FIG. 6 is a schematic, side cross-sectional view of part of an LCD device according to a sixth embodiment of the present invention. The LCD device 600 has a structure similar to that of the LCD device 100. However, in the LCD device 600, a transflective film 619 is formed between a lower storage electrode 613 and a passivation layer 617, and an upper storage electrode 618 is made of a highly reflective conductive material such as Al, Ag, AlNd, or AlY. The transflective film 619 includes a plurality of layers of different transparent materials stacked one on the other in alternating fashion. The layers are typically selected from the group consisting of one or more SiO₂ films, TiO₂ films, Nb₂O₅ films, ZnO₂ films, and Si₃N₄ films.

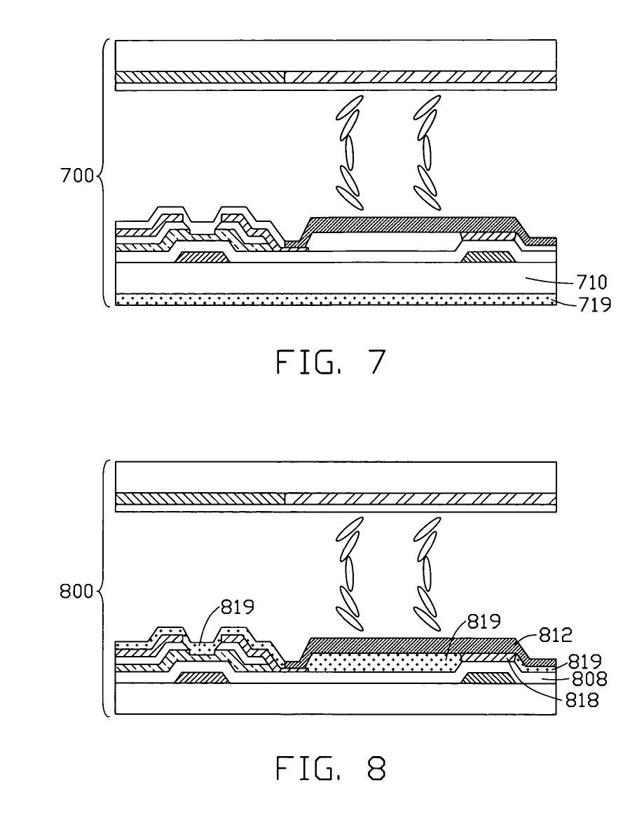

FIG. 7 is a schematic, side cross-sectional view of part of an LCD device according to a seventh embodiment of the present invention. The LCD device 700 has a structure similar to that of the LCD device 100. However, in the LCD device 700, a transflective film 719 is formed on an outer surface of a lower substrate 710. The transflective film 719 includes a plurality of layers of different transparent materials stacked one on the other in alternating fashion. The layers are typically selected from the group consisting of one or more SiO₂ films, TiO₂ films, Nb₂O₅ films, ZnO₂ films, and Si₃N₄ films.

FIG. 8 is a schematic, side cross-sectional view of part of an LCD device according to an eighth embodiment of the present invention. The LCD device 800 has a structure similar to that of the LCD device 100. However, in the LCD device 800, a transflective film 819 is formed between an isolation film 808 and a pixel electrode 812, and an upper storage electrode 818 is made of a highly reflective conductive material such as Al, Ag, AlNd, or AlY. The transflective film 819 and the upper storage electrode 818 are formed at a substantially same layer. The transflective film 819 includes a plurality of layers of different transparent materials stacked one on the other in alternating fashion. The layers are typically selected from the group consisting of one or more SiO₂ films, TiO₂ films, Nb₂O₅ films, ZnO₂ films, and Si₃N₄ films.

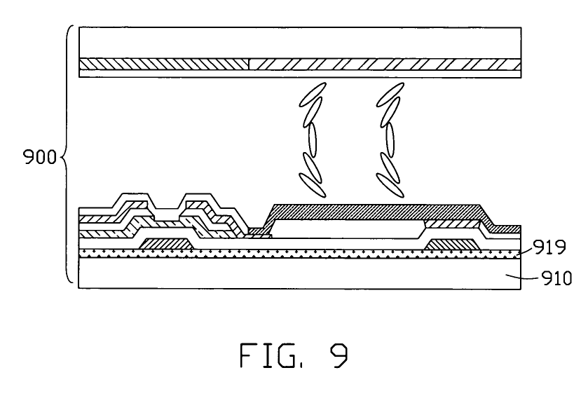

FIG. 9 is a schematic, side cross-sectional view of part of an LCD device according to a ninth embodiment of the present invention. The LCD device 900 has a structure similar to that of the LCD device 100. However, in the LCD device 900, a transflective film 919 is directly formed on an inner surface of a lower substrate 910. The transflective film 919 includes a plurality of layers of different transparent materials stacked one on the other in alternating fashion. The layers are typically selected from the group consisting of one or more SiO₂ films, TiO₂ films, Nb₂O₅ films, ZnO₂ films, and Si₃N₄ films.

In alternative embodiments, as regards the LCD device 200, the pixel electrode 212 covered by the reflector 218 can have a plurality of bumps. As regards the LCD device 300, the lower storage electrode 313 can have a plurality of bumps. As regards any of the LCD devices 100, 200, 300, 400, 500, 600, 700, 800, 900, the transflective film may be a highly reflective metal film having a plurality of holes therein. As regards any of the LCD devices 100-900, a diffuser may be disposed on or at a surface of the upper substrate.

With any of the above-described constructions, the LCD device can effectively use light emitted from the backlight and passing through the transflective area when the ambient light is low, and light reflected by both the transflective area and the reflection area when the ambient light is high. Further, both the transflective area and the reflection area can be used to generate a display, therefore the LCD device is capable of providing a display both in a reflection mode and a transmission mode simultaneously. Moreover, the LCD device can provide a bright display under various ambient light conditions.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display device, comprising:
a first substrate and a second substrate;
a liquid crystal layer having liquid crystal molecules interposed between the first and second substrates;
a pixel electrode disposed at an inner surface of the first substrate;
a common electrode disposed at an inner surface of the second substrate; and
a storage capacitor having an upper storage electrode and a lower storage electrode disposed at the inner surface of the first substrate, the upper storage electrode electrically connecting with the pixel electrode;
wherein one of the storage electrodes functions as a reflection electrode and a transflective film is formed at the first substrate, so as to provide reflective and transmission display functions simultaneously.

2. The liquid crystal display device as claimed in claim 1, wherein the transflective film is formed on the inner surface of the first substrate.

3. The liquid crystal display device as claimed in claim 2, wherein the transflective film comprises a plurality of layers of different transparent materials stacked one on the other in alternating fashion.

4. The liquid crystal display device as claimed in claim 3, wherein the layers of the transflective film comprise one or more films selected from the group consisting of a SiO₂ film, a TiO₂ film, a Nb₂O₅ film, a ZnO₂ film, and a Si₃N₄ film.

5. The liquid crystal display device as claimed in claim 1, wherein the transflective film is formed at an outer surface of the first substrate.

6. The liquid crystal display device as claimed in claim 5, wherein the transflective film comprises a plurality of layers of different transparent materials stacked one on the other in alternating fashion.

7. The liquid crystal display device as claimed in claim 6, wherein the layers of the transflective film comprise one or more films selected from the group consisting of an SiO₂ film, a TiO₂ film, a Nb₂O₅ film, a ZnO₂ film, and a Si₃N₄ film.

8. The liquid crystal display device as claimed in claim 1, wherein the transflective film is a highly reflective metal film having a plurality of holes therein.

9. The liquid crystal display device as claimed in claim 1, wherein the upper storage electrode is a reflection electrode.

10. The liquid crystal display device as claimed in claim 9, wherein the upper storage electrode is made of a material selected from the group consisting of Al, Ag, AlNd, and AlY.

11. The liquid crystal display device as claimed in claim 10, wherein the upper storage electrode comprises a transparent electrode and a reflector, and the reflector covers the transparent electrode.

12. The liquid crystal display device as claimed in claim 11, wherein the reflector is made of a material selected from the group consisting of Al, Ag, AlNd, AlY, and resin.

13. The liquid crystal display device as claimed in claim 9, wherein a surface of the upper storage electrode has a plurality of bumps.

14. The liquid crystal display device as claimed in claim 1, wherein the lower storage electrode is a reflection electrode, and the upper storage electrode is a transparent electrode.

15. The liquid crystal display device as claimed in claim 14, wherein the lower storage electrode is made of a material selected from the group consisting of Al, Ag, AlNd, and AlY.

16. The liquid crystal display device as claimed in claim 15, wherein a surface of the lower storage electrode has a plurality of bumps.

17. The liquid crystal display device as claimed in claim 1, further comprising a diffuser disposed at a surface of the second substrate.

18. A liquid crystal display device, comprising:
a first substrate and a second substrate;
a liquid crystal layer having liquid crystal molecules interposed between the first and second substrates;
a pixel electrode disposed at an inner surface of the first substrate;
a common electrode disposed at an inner surface of the second substrate; and
a storage capacitor having an upper storage electrode and a lower storage electrode disposed at the inner surface of the first substrate, the upper storage electrode electrically connecting with the pixel electrode;
wherein a reflection electrode is provided around the first substrate, and a transflective film is formed at the first substrate, so as to provide reflective and transmission display functions simultaneously.
